(19) United States
(12) Patent Application Publication
(10) Pub. No.: US 2026/0145327 A1
(43) Pub. Date: May 28, 2026

(54) METHOD OF CONTROLLING ROBOT, AND ROBOT SYSTEM

(71) Applicant: SEIKO EPSON CORPORATION, Tokyo (JP)

(72) Inventors: Tomohisa IWAZAKI, SHIMOSUWA-MACHI (JP); Yutaka ARAKAWA, HARA-MURA (JP)

(21) Appl. No.: 19/400,998

(22) Filed: Nov. 25, 2025

(30) Foreign Application Priority Data
Nov. 27, 2024 (JP) 2024-206181

(51) Int. Cl. B25J 9/16; B25J 13/08; B25J 19/02

(52) U.S. Cl. CPC B25J 9/1664; B25J 9/1697; B25J 13/088; B25J 19/022; B25J 19/023

(57) ABSTRACT

There is provided a method of controlling a robot including a robot arm, a tool disposed on the robot arm and configured to perform work on an object along a work trajectory, and an optical sensor having a fixed relative positional relationship with the tool and configured to measure a displacement of an actual position from the work trajectory. The robot is controlled by a control device and performs the work on the object by moving the tool relative to the object. The method includes: moving the tool based on the work trajectory, causing the optical sensor to measure elapsed time and the displacement from when the robot receives, from the control device, a trigger signal for starting an operation; and determining start time of the work by the tool based on data indicating the elapsed time and the displacement obtained in the measuring.

### CROSS-REFERENCE TO RELATED APPLICATIONS

The present application is based on, and claims priority from JP Application Serial Number 2024-206181, filed Nov. 27, 2024, the disclosure of which is hereby incorporated by reference herein in its entirety.

### BACKGROUND OF THE INVENTION

### 1. Technical Field

The present disclosure relates to a method of controlling a robot, and a robot system including the robot.

### 2. Related Art

JP-A-2013-202781 discloses a printing system that performs printing on an object by ejecting ink to the object while moving a robot including a print head attached to a distal end of the robot along a printing trajectory. According to this document, printing is performed along two laterally adjacent printing trajectories A and B.

However, in the printing system disclosed in JP-A-2013-202781, positional errors with respect to the printing trajectories may occur due to a dimensional error, speed unevenness, vibration, or another factor of the robot, and work may not be started from an accurate position.

### SUMMARY OF THE INVENTION

According to an aspect of the present disclosure, there is provided a method of controlling a robot including a robot arm, a tool disposed on the robot arm and configured to perform work on an object along a work trajectory, and an optical sensor having a fixed relative positional relationship with the tool and configured to measure a displacement of an actual position from the work trajectory, the robot is controlled by a control device and performs the work on the object by moving the tool relative to the object, and the method includes: moving the tool based on the work trajectory and causing the optical sensor to measure elapsed time and the displacement from when the robot receives, from the control device, a trigger signal for starting an operation; and determining start time of the work by the tool based on data indicating the elapsed time and the displacement obtained in the measuring.

According to another aspect of the present disclosure, there is provided a robot system including: a robot including a robot arm, a tool disposed on the robot arm and configured to perform work on an object, and an optical sensor having a fixed relative positional relationship with the tool and configured to measure a displacement of an actual position from a work trajectory; and a control device that transmits, to the robot, a trigger signal for starting an operation, wherein upon receiving the trigger signal, the robot moves the tool based on the work trajectory, causes the optical sensor to measure elapsed time and the displacement from when the robot receives the trigger signal, and determines start time of the work by the tool based on data indicating the measured elapsed time and the measured displacement.

### BRIEF DESCRIPTION OF DRAWINGS

FIG. 1 is a schematic configuration diagram of a robot system according to a first embodiment.

FIG. 2 is a plan view of a support plate.

FIG. 3 is a cross-sectional view of an optical sensor.

FIG. 4 is a schematic diagram illustrating the detection principle of the optical sensor.

FIG. 5 is a block diagram of a control device.

FIG. 6 is a flowchart illustrating a process flow for a method of correcting a printing trajectory.

FIG. 7 is a graph illustrating an aspect of the progress of correction.

FIG. 8 is a plan view of a support plate according to a second embodiment.

FIG. 9 is a flowchart illustrating a process flow for a method of correcting a printing trajectory.

FIG. 10 is a plan view of a support plate according to a third embodiment.

FIG. 11 is a diagram illustrating an aspect of a gap between an object and a print head.

FIG. 12 is a diagram illustrating another aspect of the gap relationship between the object and the print head.

FIG. 13 is a diagram illustrating still another aspect of the gap relationship between the object and the print head.

### DETAILED DESCRIPTION OF THE INVENTION

### First Embodiment

### Overview of Robot System

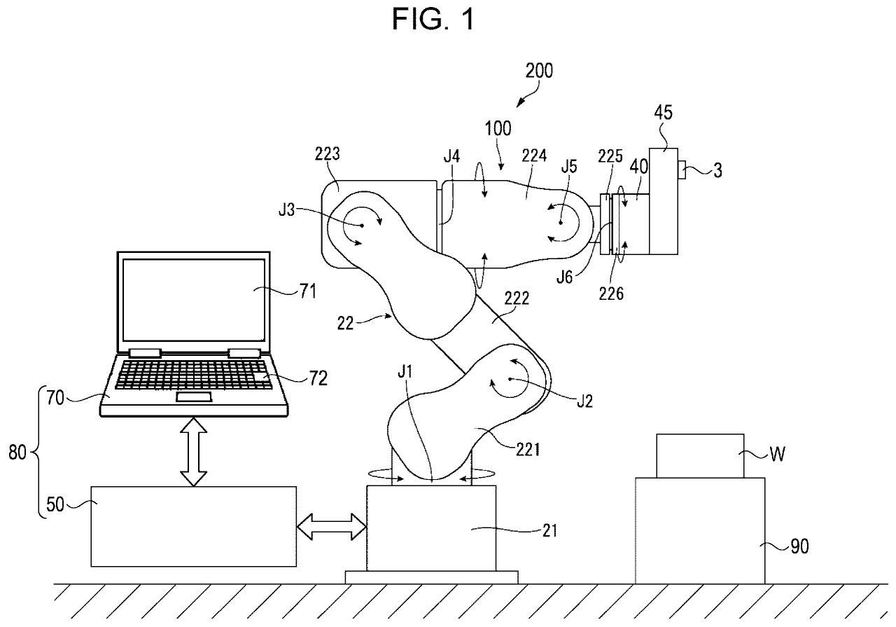

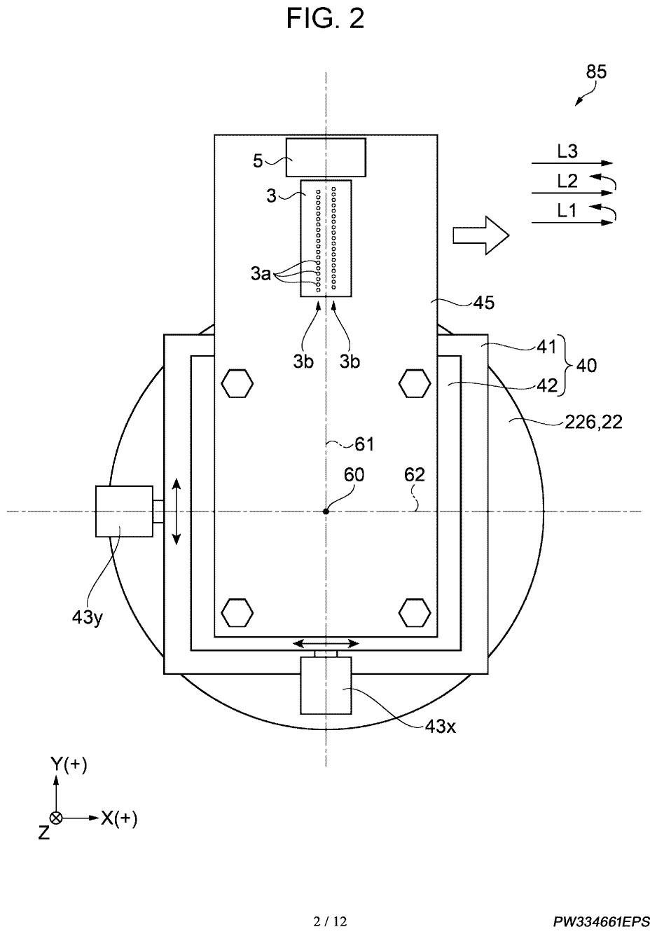

FIG. 1 is a schematic configuration diagram of a robot system according to a first embodiment. FIG. 2 is a plan view of a support plate. Hereinafter, embodiments of the present disclosure will be described with reference to the drawings.

The robot system 200 according to the present embodiment is a printing system that performs printing on an object W that is a workpiece mounted on a workbench 90. The robot system 200 includes a robot 100, a control device 80 that controls the operation of the robot 100, and the like.

In a preferred example, the robot 100 is a six-axis vertical articulated robot having six drive axes, and includes a robot arm 22, a movable stage 40 disposed at a distal end of the robot arm 22, a support plate 45 fixed to the movable stage 40, a print head 3 that is a tool disposed on the support plate 45, and the like.

The robot 100 is a six-axis vertical articulated robot, and includes a base 21 and the robot arm 22 rotatably coupled to the base 21.

The robot arm 22 includes six arms 221, 222, 223, 224, 225, and 226 rotatably coupled in this order from the base 21 side, and includes six joints J1, J2, J3, J4, J5, and J6. Among the joints J1 to J6, the joints J2, J3, and J5 are bending joints, and the joints J1, J4, and J6 are torsional joints. In each of the joints J1 to J6, a drive mechanism including a motor as a drive source and an encoder that detects a rotation amount of the joint is incorporated. Note that the robot 100 is not limited to a six-axis vertical articulated robot, and may be any robot on which the tool can be mounted. For example, as the robot 100, a horizontal articulated robot (SCARA robot) or an orthogonal robot may be used. In the case of using the orthogonal robot, it is preferable to use a plurality of orthogonal robots in combination.

FIG. 2 is a plan view of the support plate 45 as viewed from the object W side.

As illustrated in FIG. 2, the movable stage 40 is attached to the arm 226 at the distal end of the robot arm 22. In FIG. 2, the center of the cylindrical arm 226 is defined as a center point 60. A line segment passing through the center point 60 and the center of the print head 3 is defined as a center line 61, and a line segment passing through the center point 60 and orthogonal to the center line 61 is defined as a center line 62. In each of the drawings, an X-axis, a Y-axis, and a Z-axis are illustrated as three axes orthogonal to each other. In the present embodiment, a direction in which the center line 61 extends is defined as a Y plus direction, and a direction in which the center line 62 extends is an X plus direction. Both a direction toward the plus side in the Y direction and a direction toward the minus side in the Y direction are referred to as the Y direction. The same applies to the X direction and the Z direction. In addition, a Z plus direction is a vertically upward direction. The Z plus direction is also referred to as an upward direction and a Z minus direction is also referred to as a downward direction.

The movable stage 40 is an XY stage, and includes a Y plate 41 and an X plate 42 that overlap each other.

A drive section 43y is disposed on one side of the Y plate 41 extending in the Y direction. The drive section 43y is a piezoelectric actuator that is driven by using expansion and contraction of a piezoelectric element due to application of current to the piezoelectric element, and can move the Y plate 41 in the Y direction as indicated by an arrow in FIG. 2.

A drive section 43x is disposed on one side of the X plate 42 extending in the X direction. The drive section 43x is a piezoelectric actuator identical to the drive section 43y, and can move the X plate 42 in the X direction as indicated by an arrow in FIG. 2. By using the piezoelectric actuators as the drive sections 43x and 43y, the movable stage 40 can be driven at high speed and with high accuracy. Note that the drive sections 43x and 43y are not limited to the piezoelectric actuators, and may be actuators capable of driving the movable stage 40. For example, each of the drive sections 43x and 43y may include a motor.

The support plate 45 is attached to the movable stage 40. The support plate 45 is a rectangular plate-like member, and a portion of the support plate 45 that includes a short side on the minus side in the Y direction is fixed to the movable stage 40. As illustrated in FIG. 2, a short-side portion of the support plate 45 in the Y plus direction is a protruding region protruding from the movable stage 40.

The print head 3 and an optical sensor 5 are disposed on the protruding region of the support plate 45. The print head 3 is not particularly limited, but an ink jet head is used as the print head 3 in the present embodiment. As illustrated in FIG. 2, the print head 3 has two nozzle rows 3b extending in the Y direction. Each of the nozzle rows 3b is an array of a plurality of nozzles 3a. The print head 3 is disposed along the center line 61. The print head 3 is capable of performing printing of a band length corresponding to the two nozzle rows 3b in accordance with a command from the control device 80 along with movement in the X direction. The number of nozzle rows 3b is not limited to two, and may be appropriately set according to design specifications including resolution. In other words, the robot 100 includes the movable stage 40 disposed between the robot arm 22 and the print head 3 and configured to displace the print head 3.

### Configuration of Optical Sensor

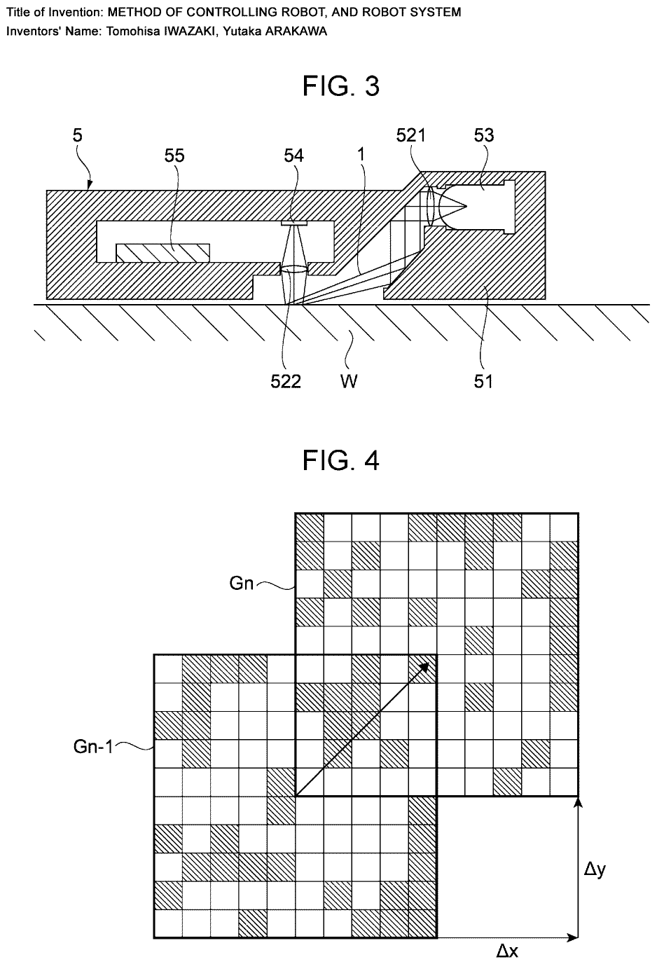

FIG. 3 is a cross-sectional view of the optical sensor. FIG. 4 is a schematic diagram illustrating the detection principle of the optical sensor.

The optical sensor 5 is disposed on the Y plus side of the print head 3. The optical sensor 5 is an optical tracking sensor that is widely applied to an optical mouse. The relative positional relationship between the optical sensor 5 and the print head 3 is fixed.

The optical sensor 5 has an X axis and a Y axis that are two detection axes orthogonal to each other, and is capable of independently detecting an amount Δx of displacement in the X direction and an amount Δy of displacement in the Y direction. Note that the amounts of displacement are also referred to as amounts of translation.

As illustrated in FIG. 2, the optical sensor 5 has a rectangular shape extending in the X direction in plan view. The shape of the optical sensor 5 is not particularly limited, and may be a rectangular shape extending in the Y direction, a square shape, a circular shape, or the like.

As illustrated in FIG. 3, the optical sensor 5 includes a base 51, a pair of lens members 521 and 522, a light source 53, an imaging element 54, and a processing circuit 55.

The base 51 is disposed to face the object W. Light 1 emitted by the light source 53 is guided to a front surface of the object W by the lens member 521 and a reflecting surface formed on an inner surface of the base 51, and is reflected by the front surface of the object W, collected by the lens member 522, and received by the imaging element 54. The imaging element 54 continues capturing an image at a time interval of about 1 ms, and the processing circuit 55 obtains the amount of displacement of the optical sensor 5 relative to the object W based on the image captured by the imaging element 54.

Specifically, as illustrated in FIG. 4, since the object W is irradiated with the light 1, light and dark areas corresponding to minute irregularities on the front surface of the object W appear in the image captured by the imaging element 54.

Then, the processing circuit 55 compares an image Gn newly captured by the imaging element 54 with an image Gn-1 previously captured by the imaging element 54, and detects the amount of movement of the image Gn relative to the image Gn-1 using an optical flow method or the like. That is, the amount of movement of the image Gn relative to the image Gn-1 is detected by comparing brightness information of the image Gn with brightness information of the image Gn-1. Then, the processing circuit 55 detects, based on the result of the detection, the amounts Δx and Δy of displacement of the optical sensor 5 relative to the object W from the time when the image Gn-1 is acquired to the time when the image Gn is acquired, and transmits detected data indicating the detected amounts Δx and Δy of displacement to the control device 80.

As illustrated in FIG. 3, by irradiating the object W with the light 1 from an oblique direction, that is, from a direction inclined with respect to the normal line of the surface of the object W to be printed, light and dark areas appear more clearly, and the amounts Δx and Δy of displacement can be more accurately detected. The light source 53 is not particularly limited, and for example, a light emitting diode (LED), a laser light source, or the like may be used as the light source 53. The light 1 from the light source 53 is not particularly limited, and for example, the light 1 may be red light, blue light, infrared light, or the like. The imaging element 54 is not particularly limited, and for example, a CCD image sensor, a CMOS image sensor, or the like may be used as the imaging element 54.

In other words, the optical sensor 5 is an optical tracking sensor, includes the light source 53, the lens member 521 that irradiates, from the oblique direction, the object W with the light 1 from the light source 53, and the imaging element 54 that receives the light reflected by the object W, and the optical sensor 5 measures a displacement of the print head 3 by comparing the brightness information of the two images captured by the imaging element 54.

As can be seen from the fact that the optical sensor 5 is widely applied to an optical mouse, the optical sensor 5 is inexpensive and compact, and has high detection accuracy. Therefore, by using the optical sensor 5, it is possible to obtain the robot 100 and the robot system 200 capable of performing highly accurate position detection, while achieving cost reduction and miniaturization.

In other words, the robot 100 includes the robot arm 22, the print head 3 that is the tool disposed on the robot arm 22 and configured to perform work on the object W along the printing trajectory as a work trajectory, and the optical sensor 5 that has a fixed relative positional relationship with the print head 3 and measures a displacement of the actual position from the work trajectory.

### Overview of Control Device

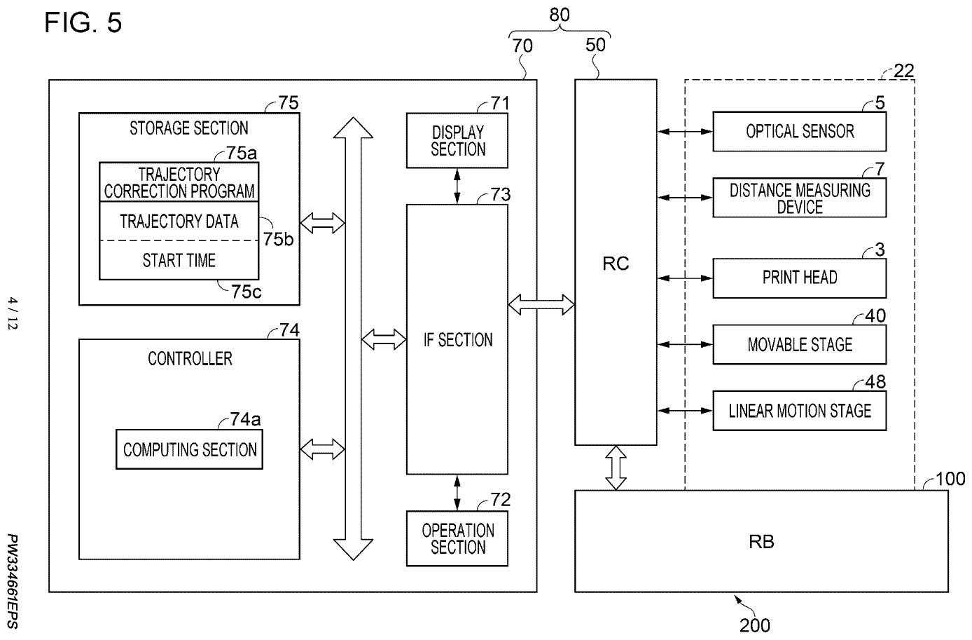

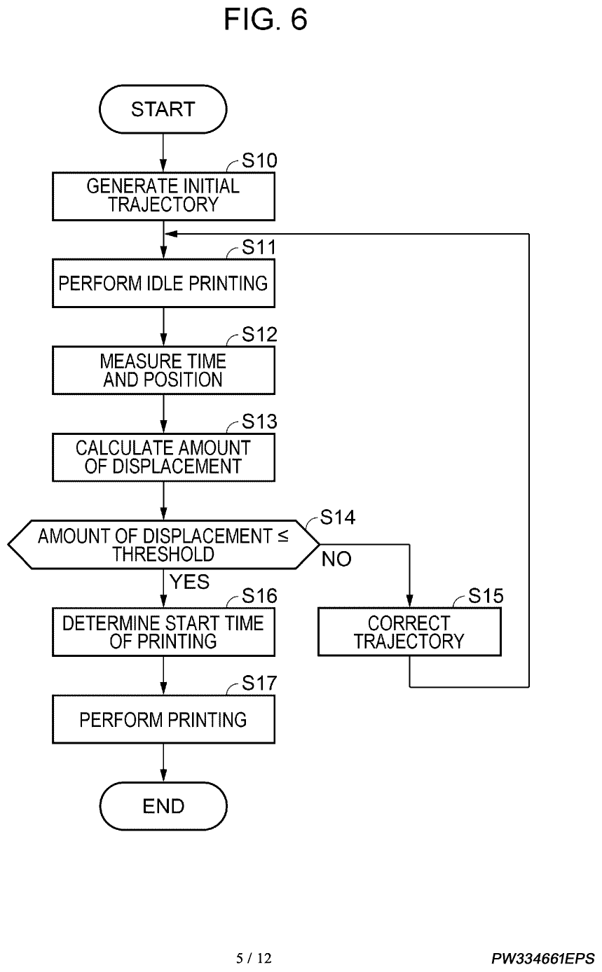

FIG. 5 is a block configuration diagram of the control device.

The control device 80 includes a robot controller 50 and a computer 70. The robot controller 50 is a control circuit including one or a plurality of processors (not illustrated) and a storage circuit (not illustrated), and comprehensively controls the operation of the robot 100 by operating in accordance with a control program. For example, the control device 80 transmits a trigger signal for starting an operation to the robot 100. The robot controller 50 is coupled to the computer 70, and performs printing on the object W by the print head 3 in accordance with trajectory data supplied from the computer 70. The data detected by the optical sensor 5 is transmitted to the computer 70 via the robot controller 50.

As illustrated in FIG. 5, the robot 100, the optical sensor 5, the print head 3, the movable stage 40, and the like are coupled to the robot controller 50.

Measured data obtained by the optical sensor 5 is transmitted to the computer 70 via the robot controller 50, and is used for calculation, accumulation, and repeated learning.

In a preferred example, as the computer 70, a laptop computer including a display section 71 having a liquid crystal panel and an operation section 72 having a keyboard is used. The operation section 72 may be a touch panel disposed in the display section 71 or may be a mouse. The computer 70 also includes an IF section 73, a controller 74, and a storage section 75.

The IF section 73 is an interface section with the robot controller 50, and includes a plurality of coupling terminals and an interface circuit.

The controller 74 includes one or a plurality of processors, and is coupled to each section of the computer 70 including the storage section 75 via a bus line. The controller 74 can also function as a computing section 74a when executing a trajectory correction program described later.

The storage section 75 includes a random-access memory (RAM) and a read-only memory (ROM). The RAM is used for temporarily storing various data and the like, and the ROM stores the control program for controlling the operation of the robot 100, accompanying data, and the like. In the control program, a boot program for instructing the order and contents of processing for starting the robot 100, the trajectory correction program 75a described later, and the like are stored. The accompanying data includes trajectory data 75b including initial trajectory data, start time data 75c for a trajectory, and the like.

### Method of Correcting Printing Trajectory

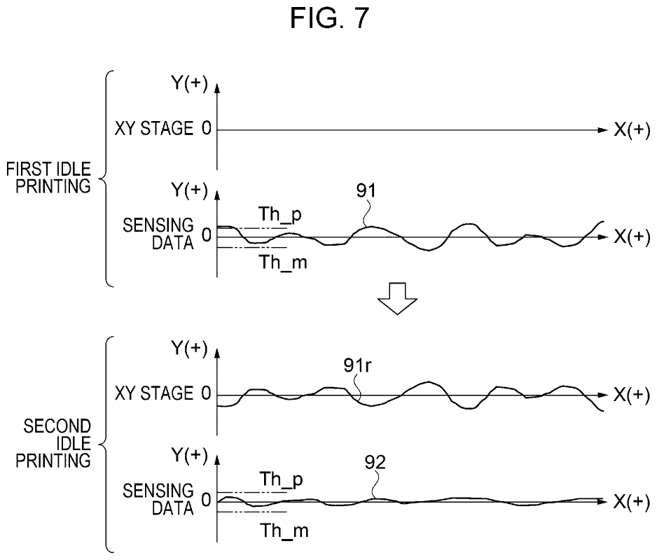

FIG. 6 is a flowchart illustrating a process flow for a method of correcting a printing trajectory. FIG. 7 is a graph illustrating an aspect of the progress of correction.

The method of correcting the printing trajectory and a method of determining the start time of printing will be described mainly with reference to FIG. 6 and other drawings as appropriate. Each of the following steps is executed by the robot controller 50 mainly controlling the robot 100 in accordance with the trajectory correction program 75a of the computer 70. Processing in these steps corresponds to a method of controlling the robot according to the present embodiment.

First, an example of the printing trajectory will be described with reference to FIG. 2. A printing trajectory 85 illustrated in the upper right of FIG. 2 is an example of a scanning trajectory of the print head 3 for printing on the object W. The print head 3 performs printing on the object W (FIG. 1) by ejecting ink while performing scanning along the printing trajectory 85 with the movement of the support plate 45. In the following description, it is assumed that the object W is a box-shaped workpiece and that printing is performed on a flat upper surface of the object W.

As illustrated in FIG. 2, the printing trajectory 85 includes a trajectory L1, a trajectory L2, and a trajectory L3, which are linear trajectories. Specifically, in the printing trajectory 85, the print head 3 performs printing in the X plus direction along the trajectory L1 from the start position of the trajectory L1, performs printing in the X plus direction along the trajectory L2 after returning to the start position of the trajectory L2 in an X minus direction, and performs printing in the X plus direction along the trajectory L3 after returning to the start position of the trajectory L3 in the X minus direction. The trajectory L1 includes a plurality of teaching points. The same applies the trajectories L2 and L3. The printing trajectory 85 is a simplified trajectory for explanation, and the actual printing trajectory is not limited thereto. For example, the printing trajectory may have an angle with respect to the X axis, or may include a bent portion or a curved line.

In step S10, the computer 70 generates an initial trajectory. It is assumed that the trajectory correction program 75a stored in the storage section 75 of the computer 70 is executed and that the printing trajectory 85 (FIG. 2) is read from the trajectory data 75b. The printing trajectory 85 may be calculated from CAD data of the object W, printing position data, and the like.

In step S11, the print head 3 performs idle printing while moving along the trajectory L1 of the printing trajectory 85. Specifically, in step S11, the print head 3 does not perform printing, and scanning is performed with the support plate 45 moving along the trajectory L1. In this case, the movable stage 40 is stopped.

In step S12, the actual position of the print head 3 is measured by the optical sensor 5 in accordance with the scanning with the support plate 45. Specifically, in the measurement step, the actual position of the print head 3 is measured by moving the print head 3 based on the plurality of teaching points forming the trajectory L1 as a preset work trajectory and comparing two images captured by the imaging element 54 of the optical sensor 5 at different imaging timings. In this case, the elapsed time and the displacement from the time when the robot 100 receives, from the control device 80, the trigger signal for starting the operation are measured. In other words, in the measurement step, the print head 3 is moved based on the printing trajectory, and the optical sensor 5 measures the elapsed time and the displacement from when the robot 100 receives, from the control device 80, the trigger signal for starting the operation of the robot arm 22.

In step S13, an amount of displacement of the position measured by the optical sensor 5 from the initial trajectory L1 is calculated. Specifically, in the calculation step, the controller 74 functions as the computing section 74a and calculates an amount of displacement of the measured position from the initial trajectory L1 for each of the teaching points on the initial trajectory L1. The amount of displacement is also referred to as a deviation.

A graph 91 in FIG. 7 is obtained by graphing an example of the calculated displacement. The graph 91 indicates the displacement in the first idle printing. The horizontal axis represents the trajectory L, and the vertical axis represents the amount of displacement (mm). As illustrated in FIG. 7, the graph 91 undulates up and down, and it is understood that portions exceeding a line indicating a threshold Th are present. As illustrated in a graph above the graph 91, the movable stage 40 is stopped during the first idle printing.

In step S14, it is determined whether the amount of displacement of the measured actual position from the initial trajectory L1 is less than or equal to the threshold Th. If the amount of the displacement is less than or equal to the threshold Th, the trajectory is set as the printing trajectory, and the process flow proceeds to step S16. If the amount of the displacement exceeds the threshold Th, the process flow proceeds to step S15.

In step S15, a corrected trajectory for correcting the initial trajectory L1 is generated, and the process returns to step S11.

A graph 91r in FIG. 7 is an example of the corrected trajectory. The graph 91r is a waveform opposite in phase to the graph 91. Then, as illustrated in FIG. 7, in the second idle printing, scanning is performed with the support plate 45 moving along the corrected trajectory while the movable stage 40 is driven in accordance with the waveform of the graph 91r. In other words, the position of the print head 3 is corrected by driving the movable stage 40.

A graph 92 in FIG. 7 indicates the displacement in the second idle printing. As indicated by the graph 92, it can be seen that the displacement is less than that in the graph 91 and is less than or equal to the threshold Th. Note that the method of correcting the trajectory is not limited to the above-described method, and any method may be used as long as the amount of displacement can be kept less than or equal to the threshold Th.

In step S16, the optimum time to start printing is calculated from the data indicating the elapsed time and the displacement measured in the above manner, and the start time of printing is determined. Specifically, the time taken for the print head to move a predetermined distance after the reception of the trigger signal for starting the operation is calculated. The predetermined distance is the distance to the start position of the printing trajectory. The start time of printing is stored in the start time data 75c of the storage section 75. In other words, in the determination step, the start time of printing by the print head 3 is determined based on the data indicating the elapsed time and the displacement obtained in the measurement step.

In step S17, printing is performed according to the set printing trajectory. Specifically, after the robot arm 22 starts the operation in response to the reception of the trigger signal for starting the operation, the printing is performed along the printing trajectory at the start time of the printing. When industrial robots including the robot 100 are driven along the same work trajectory under the same conditions, the trajectory is reproduced. Therefore, at the start time of the printing based on the measured data obtained by the actual operation in the measurement step, the print head 3 is positioned at the start position of the printing trajectory in which the position at the time of the measurement is reproduced. Therefore, the printing can be performed at a predetermined printing position on the object W.

Although the method using the movable stage 40 has been described above as a preferred example, the movable stage 40 may be omitted. In other words, the above-described method can be applied even to a robot that does not include the movable stage 40. Specifically, the robot arm 22 may perform the driving in accordance with the graph 92r opposite in phase to the graph 92, instead of the movable stage 40. Even in this method, the printing trajectory can be corrected in a similar manner to the method described above.

As described above, according to the method of controlling the robot 100 and the robot system 200 according to the present embodiment, the following effects can be obtained.

There is provided the method of controlling the robot 100 that includes the robot arm 22, the print head 3 that is the tool disposed on the robot arm 22 and configured to perform work on the object W along a printing trajectory as a work trajectory, and the optical sensor 5 that has the fixed relative positional relationship with the print head 3 and measures a displacement of the actual position from the printing trajectory, the control device 80 controls the robot 100, and the robot 100 performs the work on the object W by moving the print head 3 relative to the object W. The method includes: the measurement step of moving the print head 3 based on the printing trajectory and causing the optical sensor 5 to measure the elapsed time and the displacement from when the robot 100 receives, from the control device 80, the trigger signal for starting the operation; and determining start time of printing by the print head 3 based on data indicating the elapsed time and the displacement obtained in the measurement step.

In the related art, a start position of printing on a work trajectory is determined using a robot coordinate system. In this case, there is a possibility that printing may be started from a position deviated from a position at which printing is originally desired to be started due to a trajectory error of the robot. However, according to this method, the start time of the printing by the print head 3 is determined based on the data indicating the elapsed time and the displacement obtained in the measurement step. Then, after the robot arm 22 starts the operation in response to the reception of the trigger signal for starting the operation, the printing is performed along the printing trajectory at the start time of the printing. When industrial robots including the robot 100 are driven along the same work trajectory under the same conditions, the trajectory is reproduced. Therefore, at the start time of the printing, the print head 3 is positioned at the start position of the printing trajectory in which the position at the time of measurement is reproduced.

Therefore, the start position of the printing operation can be determined in consideration of an actual operation error of the robot arm 22. Therefore, it is possible to provide the method of controlling the robot 100 capable of starting work from an accurate position.

The tool is the print head 3, and the work trajectory is the printing trajectory.

According to this method, it is possible to perform printing at a predetermined printing position on the object W.

The optical sensor 5 is an optical tracking sensor and includes the light source 53, the lens member 521 that irradiates, from the oblique direction, the object W with the light 1 from the light source 53, and the imaging element 54 that receives the light reflected by the object W. The optical sensor 5 measures the displacement of the print head 3 by comparing brightness information of two images captured by the imaging element 54 at different imaging timings.

According to this configuration, even in a case where a pattern for image processing is not provided on the object W, the optical sensor 5 can measure the amount of movement of the print head 3 as the tool.

The robot 100 includes the movable stage 40 disposed between the robot arm 22 and the print head 3 and configured to displace the print head 3, and corrects the position of the print head 3 by driving the movable stage 40.

According to this configuration, responsiveness is improved and it is possible to more accurately correct the position of the print head 3, as compared to a case where the position of the print head 3 is corrected by the driving of the robot arm 22.

The movable stage 40 is driven by the piezoelectric actuators.

According to this configuration, it is possible to drive the movable stage 40 without generating a large vibration.

The robot system 200 includes the robot 100 including the robot arm 22, the print head 3 that is the tool disposed on the robot arm 22 and configured to perform work on the object W, and the optical sensor 5 that has the fixed relative positional relationship with the print head 3 and measures a displacement of the actual position from the printing trajectory as the work trajectory. The robot system 200 includes the control device 80 that transmits, to the robot 100, the trigger signal for starting the operation. Upon receiving the trigger signal, the robot 100 moves the print head 3 based on the printing trajectory, causes the optical sensor 5 to measure the elapsed time and the displacement from when the robot 100 receives the trigger signal, and determines start time of the work by the print head 3 based on data indicating the measured elapsed time and the measured displacement.

According to this configuration, it is possible to provide the robot system 200 capable of starting work from an accurate position.

### Second Embodiment

### Different Aspect of Correction Method

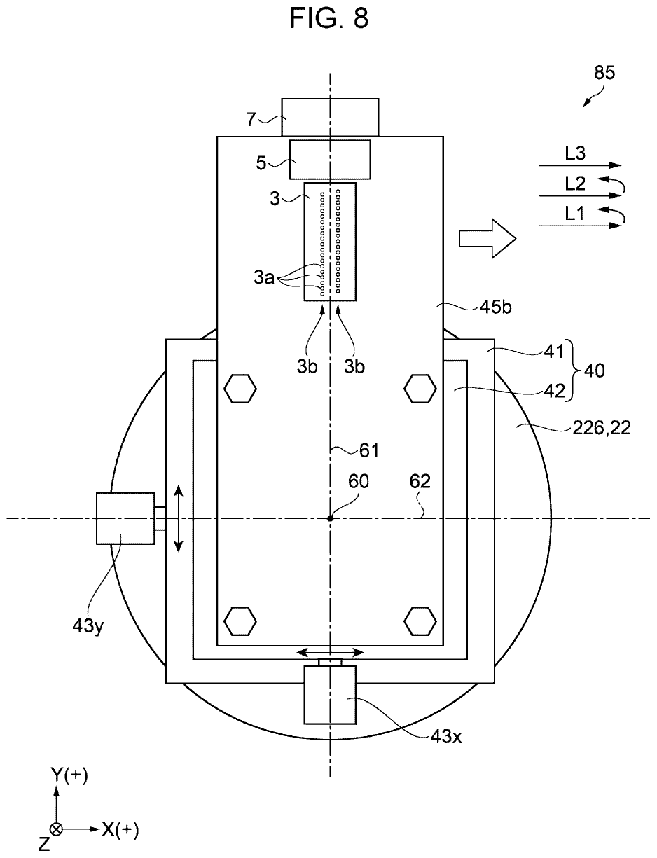

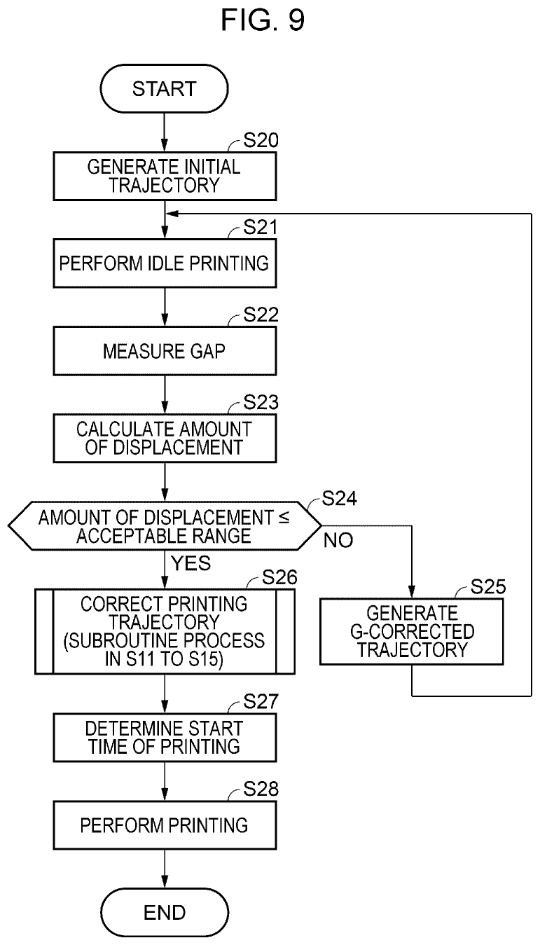

FIG. 8 is a plan view of a support plate according to a second embodiment, and corresponds to FIG. 2. FIG. 9 is a flowchart illustrating a process flow for a method of correcting a printing trajectory, and corresponds to FIG. 6.

In the above-described embodiment, the method of correcting the planar printing trajectory and determining the start time of printing has been described, but the present disclosure is not limited thereto, and a distance to the object W may also be corrected. The same portions as those in the first embodiment will be given the same reference signs, and will not be described.

As illustrated in FIG. 8, in addition to the optical sensor 5, a distance measuring device 7 is disposed on the support plate 45b according to the present embodiment. Specifically, the distance measuring device 7 is attached to an end portion of the support plate 45b on the side where a protruding region of the support plate 45b is present. The distance measuring device 7 is disposed on the Y plus side of the optical sensor 5. The print head 3, the optical sensor 5, and the distance measuring device 7 are arranged in this order along the center line 61. The relative positional relationship of the three members is fixed. In other words, the print head 3, the optical sensor 5, and the distance measuring device 7 are arranged in a direction intersecting a moving direction of the print head 3.

In a preferred example, the distance measuring device 7 uses a laser displacement gauge that irradiates the object W with laser light and detects a distance to the object W by the light reflected by the object W. The laser displacement gauge may be of a regular reflection type or a diffuse reflection type. The distance measuring device is not limited to the laser displacement gauge, and may be any distance measuring device capable of detecting a distance to the object W in a non-contact manner. For example, the distance measuring device may be a laser tracker, an infrared sensor, an ultrasonic sensor, a stereo camera, or the like.

### Method of Correcting Printing Trajectory

Step S20 is the same as step S10 in FIG. 6, and the computer 70 generates an initial trajectory in step S20. It is assumed that the trajectory correction program 75a stored in the storage section 75 of the computer 70 is executed and that the printing trajectory 85 is read from the trajectory data 75b.

In step S21, the print head 3 performs idle printing while moving along the trajectory L1 of the printing trajectory 85. Specifically, in step S21, the print head 3 does not perform printing, and scanning is performed with the support plate 45b moving along the trajectory L1.

In step S22, the distance measuring device 7 measures the distance to the object W in accordance with the scanning with the support plate 45. The distance to the object W is also referred to as distance data or a gap. Specifically, in the distance measurement step, the robot arm 22 is operated so as to follow the plurality of teaching points, and the distance to the object W is measured by the distance measuring device 7 at the plurality of teaching points on the trajectory L1. For example, the print head 3 may stop moving at each of the teaching points, and the distance measuring device 7 may measure the gap at each of the teaching points. In this manner, the measurement may be repeatedly performed.

In step S23, a displacement value between a set distance in the trajectory L1 and the distance detected by the distance measuring device 7 is calculated. Specifically, in the calculation step, the controller 74 functions as the computing section 74a, and calculates a displacement value from the set distance for each of the teaching points on the trajectory L1.

In step S24, it is determined whether the amount of displacement from each of the teaching points on the trajectory L1 is within an acceptable range of the set distance. If the amount of displacement is within the acceptable range, the process flow proceeds to step S26. If the amount of displacement exceeds the acceptable range, the process flow proceeds to step S25.

In step S25, a G-corrected trajectory in which the gap from the trajectory L1 is corrected is generated, and the process flow returns to step S21. In other words, in the correction step, the teaching points are corrected using the calculated displacement value. Specifically, in the correction step, the teaching points are corrected such that the distance measured at the teaching points approaches the reference set distance. Then, in step S21, the print head 3 performs idle printing while moving among the G-corrected trajectory. In other words, in steps S21 to S25, teaching of a robot path is performed such that a distance from the optical sensor 5 to the object W during the printing operation is within an appropriate range.

Step S26 is a subroutine process, and the processing from step S11 to step S15 in FIG. 6 is performed using, as the initial trajectory, the corrected trajectory that is the trajectory L1 in which the gap at each teaching point is optimized. Since an appropriate range of a measurable distance is determined, the optical sensor 5 can obtain data indicating accurate time and displacement in the planar trajectory in step S12 by performing measurement in the printing trajectory in which the gap is corrected to be within the appropriate range.

Step S27 is the same as step S16 in FIG. 6, and the optimum time to start printing is calculated from the data indicating the time and the displacement measured in step S26, and the start time of printing is determined. In other words, in the determination step, the start time of printing by the print head 3 is determined based on the data indicating the elapsed time and the displacement obtained in the measurement step.

In step S28, printing is performed according to the set printing trajectory. Specifically, after the robot arm 22 starts the operation in response to the reception of the trigger signal for starting the operation, the printing is performed along the printing trajectory at the start time of the printing. When industrial robots including the robot 100 are driven along the same work trajectory under the same conditions, the trajectory is reproduced. Therefore, at the start time of the printing based on the measured data obtained by the actual operation in the measurement step, the print head 3 is positioned at the start position of the printing trajectory in which the position at the time of the measurement is reproduced. Therefore, printing can be performed at a predetermined printing position on the object W.

In other words, according to the robot system 200 according to the present embodiment, the robot 100 includes the distance measuring device 7 attached to the robot arm 22 and configured to measure the distance to the object W, and the control device 80 operates the robot arm 22 so as to cause the robot arm 22 to follow the plurality of teaching points constituting the printing trajectory before measurement of the actual position, obtains distance data measured by the distance measuring device 7 at the positions of the plurality of teaching points, and corrects the teaching points such that the distance from the print head 3 to the object W at each of the teaching points during the work by the robot approaches the reference set distance.

As described above, according to the method of controlling the robot 100 and the robot system 200 according to the present embodiment, the following effects can be obtained in addition to the effects of the above-described embodiment.

According to the method of controlling the robot 100, the robot 100 further includes the distance measuring device 7 that measures the distance to the object W, and the method includes, before the measurement step in FIG. 6, the correction step of operating the robot arm 22 so as to cause the robot arm 22 to follow the plurality of teaching points constituting the printing trajectory, obtaining the distance data measured by the distance measuring device 7 at the positions of the plurality of teaching points, and correcting the teaching points such that the distance from the print head 3 to the object W at each of the teaching points during the work by the robot approaches the reference set distance.

According to this method, since a gap from the printing trajectory is corrected by the distance measuring device 7 before the measurement step by the optical sensor 5, the distance measured by the optical sensor 5 becomes substantially constant within an appropriate range in the printing trajectory, and it is possible to obtain more accurate displacement data. Therefore, it is possible to determine more accurate start time of printing.

Therefore, it is possible to provide the method of controlling the robot 100 capable of starting work from a more accurate position.

According to the robot system 200, the robot 100 includes the distance measuring device 7 attached to the robot arm 22 and configured to measure the distance to the object W, and the control device 80 operates the robot arm 22 so as to cause the robot arm 22 to follow the plurality of teaching points constituting the printing trajectory before measurement of the actual position, obtains the distance data measured by the distance measuring device 7 at the positions of the plurality of teaching points, and corrects the teaching points such that the distance from the print head 3 to the object W at each of the teaching points during the work by the robot approaches the reference set distance.

According to this configuration, it is possible to provide the robot system 200 capable of starting work from a more accurate position.

The tool is the print head 3. The print head 3, the optical sensor 5, and the distance measuring device 7 are arranged in the direction intersecting the moving direction of the print head 3.

According to this configuration, since the positions of the print head 3, the optical sensor 5, and the distance measuring device 7 are aligned, the same robot joint operation is performed at the time of printing and at the time of trajectory measurement, and thus it is possible to perform trajectory measurement on the printing trajectory with a small error. In addition, it is possible to suppress interference of the movable stage 40 with the object in a working direction in a case where the object has a portion curved in the working direction.

### Third Embodiment

### Different Arrangement of Optical Sensor and Distance Measuring Device

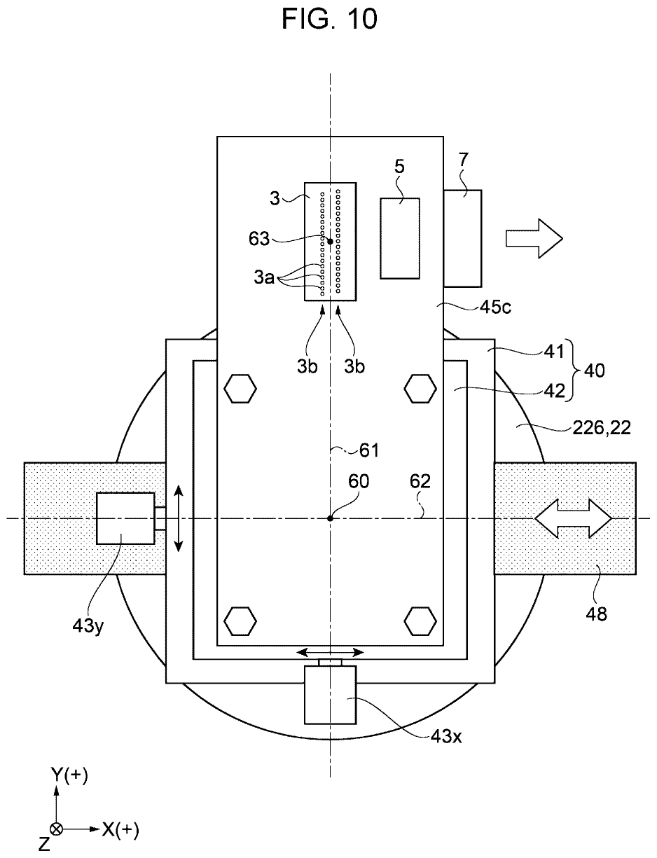

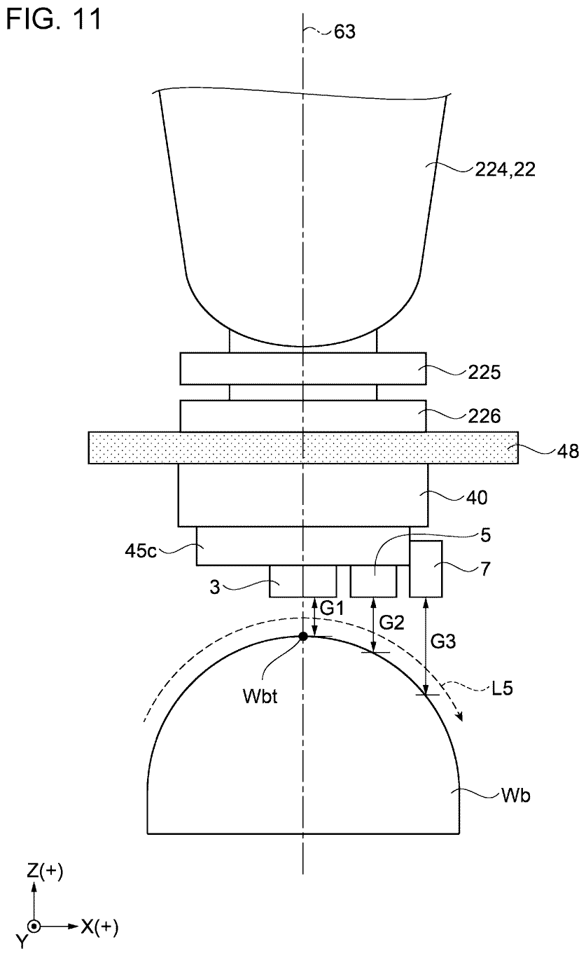

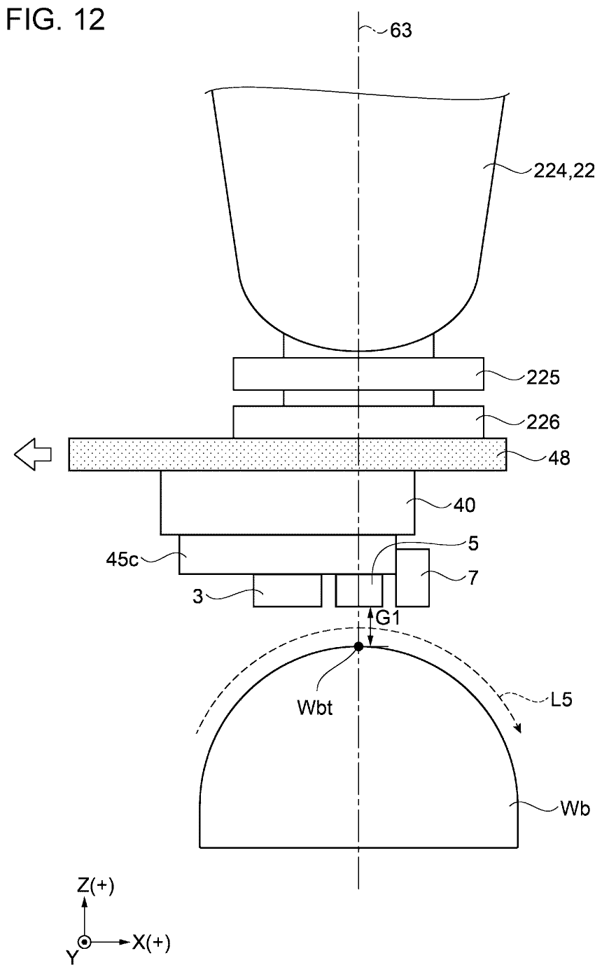

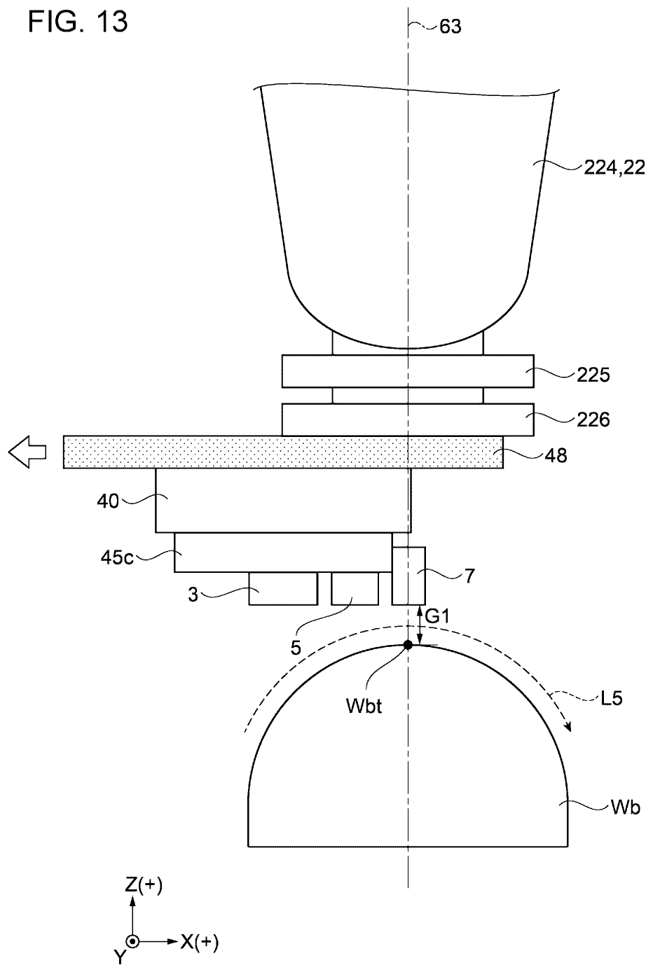

FIG. 10 is a plan view of a support plate according to a third embodiment, and corresponds to FIG. 8. FIG. 11 is a diagram illustrating an aspect of a gap between the object and the print head. FIG. 12 is a diagram illustrating another aspect of the gap between the object and the print head, and corresponds to FIG. 11. FIG. 13 is a diagram illustrating still another aspect of the gap between the object and the print head, and corresponds to FIG. 11.

In the embodiments described above, the print head 3, the optical sensor 5, and the distance measuring device 7 are arranged in the direction intersecting the moving direction of the print head 3, but the present disclosure is not limited thereto, and the print head 3, the optical sensor 5, and the distance measuring device 7 may be arranged in the moving direction of the print head 3. The object W may be an object Wb including a spherical surface. The same portions as those in the first and second embodiments will be given the same reference signs, and will not be described.

As illustrated in FIG. 10, on the support plate 45c according to the present embodiment, the print head 3, the optical sensor 5, and the distance measuring device 7 are arranged in this order in the X plus direction. The distance measuring device 7 is attached to an end portion of the support plate 45c on the X plus side. In other words, the print head 3, the optical sensor 5, and the distance measuring device 7 are disposed on the support plate 45c on the movable stage 40, and are arranged in the moving direction of the print head 3.

A linear motion stage 48 is disposed between the arm 226 at the distal end of the robot arm 22 and the movable stage 40. Except for these points, the description of the third embodiment is the same as that of the second embodiment.

The linear motion stage 48 is a linear actuator stage, and is movable in the X direction. Specifically, the linear motion stage 48 moves in the X direction in a state where the movable stage 40 and the support plate 45c are mounted on the linear motion stage 48. In other words, the linear motion stage 48 is advanceable and retractable in the moving direction of the print head 3, and the print head 3, the optical sensor 5, and the distance measuring device 7 also move together with the advance and retraction of the linear motion stage 48.

FIG. 11 is a diagram of the periphery of the support plate 45c as viewed from the Y plus side.

The object Wb that is a workpiece in the present embodiment is, for example, a helmet. The object Wb is not limited to a helmet, and may be any object Wb having a curved surface or a spherical surface.

In FIG. 11, the top of the object Wb is referred to as a top Wbt. FIG. 11 illustrates an initial state before the operation of the linear motion stage 48, and illustrates, as a work center line 63, a line segment passing through the center of the print head 3 and extending in the Z direction. In the initial state, the top Wbt of the object Wb is located on the work center line 63. As illustrated in FIG. 11, the printing trajectory for the object Wb is a trajectory L5 extending along the curved surface.

In the initial state illustrated in FIG. 11, a distance from the print head 3 to the object Wb is G1. Similarly, a distance from the optical sensor 5 to the object Wb is G2, and a distance from the distance measuring device 7 to the object Wb is G3. As illustrated in FIG. 11, since the object Wb has the spherical surface, a relationship of the distance G1<the distance G2<the distance G3 is established.

In trajectory measurement, it is desirable that both the distances G2 and G3 be equal to the distance G1. However, even if the print head 3 performs idle printing while moving along the trajectory L5 in the initial state, the gaps from the optical sensor 5 and the distance measuring device 7 are too large, and it is difficult to accurately perform the trajectory measurement.

Considering this point, in the present embodiment, the position of the optical sensor 5 or the position of the distance measuring device 7 can be switched onto the work center line 63 by driving the linear motion stage 48 in the trajectory measurement. Specifically, in FIG. 12, the linear motion stage 48 is moved in the X minus direction such that the position of the optical sensor 5 is set on the work center line 63. By performing scanning with the support plate 45c moving along the trajectory L5 in a state where the optical sensor 5 is positioned on the work center line 63, accurate trajectory measurement can be performed.

Similarly, in FIG. 13, the linear motion stage 48 is further moved in the X minus direction, and the position of the distance measuring device 7 is set on the work center line 63. Accurate distance measurement can be performed by performing scanning with the support plate 45c moving along the trajectory L5 in a state where the distance measuring device 7 is positioned on the work center line 63.

In a preferred example, similarly to the measurement order in FIG. 9, first, the distance measuring device 7 is switched to be positioned on the work center line 63 and gap measurement is performed by the idle printing, and then the optical sensor 5 is switched to be positioned on the work center line 63 and trajectory measurement is performed by the idle printing to generate a corrected trajectory. Then, printing is performed along the corrected trajectory generated by switching the print head 3 to be positioned on the work center line 63.

As described above, according to the method of controlling the robot 100 and the robot system 200 according to the present embodiment, the following effects can be obtained in addition to the effects of the above-described embodiments.

According to the robot system 200, the tool is the print head 3, and the robot system 200 includes the movable stage 40 disposed between the robot arm 22 and the print head 3 and configured to displace the print head 3. The print head 3, the optical sensor 5, and the distance measuring device 7 are disposed on the movable stage 40 and arranged in the moving direction of the print head 3.

According to this configuration, since the positions of the print head 3, the optical sensor 5, and the distance measuring device 7 are aligned, the same robot joint operation is performed at the time of printing and at the time of trajectory measurement, and thus it is possible to perform trajectory measurement on the printing trajectory with a small error. Therefore, it is possible to determine accurate start time of printing.

According to the robot system 200, the linear motion stage 48 is disposed between the robot arm 22 and the print head 3 and is advanceable and retractable in the moving direction of the print head 3, and the print head 3 and the optical sensor 5 also move together with the advance and retraction of the linear motion stage 48.

According to this, during the trajectory measurement and the distance measurement, the position of the optical sensor 5 or the position of the distance measuring device 7 is switched onto the work center line 63 by the linear motion stage 48, and thus it is possible to perform accurate measurement and to generate an accurate corrected trajectory. Therefore, it is possible to determine accurate start time of printing. Then, the position of the print head 3 is switched onto the work center line 63 by the linear motion stage 48, and printing is performed along the generated corrected trajectory. Therefore, the printing can be performed at an accurate position with high accuracy.

### Modifications

In the above description, the printing is performed on the object using the print head 3 as the tool. However, the work and the tool are not limited thereto. For example, the work may be various types of work such as adhesive application, conveyor tracking, polishing, and welding, and any tool such as a dispenser may be used instead of the print head 3. Even when the present disclosure is applied to these types of work and the tool, it is possible to obtain the same operational effects as those of the above-described embodiments.

In addition, in the above description, the optical sensor 5 is described as an optical tracking sensor, but the optical sensor 5 is not limited thereto. For example, a method of measuring and calculating acceleration of the robot or an angular velocity by an inertial sensor unit or an acceleration sensor may be used.

1. A method of controlling a robot including
a robot arm, a tool disposed on the robot arm and configured to perform work on an object along a work trajectory, and an optical sensor having a fixed relative positional relationship with the tool and configured to measure a displacement of an actual position from the work trajectory,
the robot being controlled by a control device and configured to perform the work on the object by moving the object relative to the tool, the method comprising:
moving the tool based on the work trajectory and causing the optical sensor to measure elapsed time and the displacement from when the robot receives, from the control device, a trigger signal for starting an operation; and
determining start time of the work by the tool based on data indicating the elapsed time and the displacement obtained in the measurement step.

2. The method according to claim 1, wherein
the robot further includes a distance measuring device that measures a distance to the object,
the method further comprising, before the measuring,
operating the robot arm so as to cause the robot arm to follow a plurality of teaching points constituting the work trajectory, obtaining distance data measured by the distance measuring device at positions of the plurality of teaching points, and correcting the teaching points such that a distance from the tool to the object at each of the teaching points during the work by the robot approaches a reference set distance.

3. The method according to claim 2, wherein
the tool is a print head, and
the work trajectory is a printing trajectory.

4. The method according to claim 3, wherein
the optical sensor is an optical tracking sensor and includes
a light source,
a lens member that irradiates, from an oblique direction, the object with light from the light source, and
an imaging element that receives the light reflected by the object, and
the optical sensor measures a displacement of the print head by comparing two images captured by the imaging element at different imaging timings.

5. The method according to claim 3, wherein
the robot includes a movable stage disposed between the robot arm and the print head and configured to displace the print head, and
a position of the print head is corrected by driving the movable stage.

6. The method according to claim 5, wherein
the movable stage is driven by a piezoelectric actuator.

7. A robot system comprising:
a robot including
a robot arm,
a tool disposed on the robot arm and configured to perform work on an object, and
an optical sensor having a fixed relative positional relationship with the tool and configured to measure a displacement of an actual position from a work trajectory; and
a control device that transmits a trigger signal for starting an operation to the robot, wherein
upon receiving the trigger signal, the robot moves the tool based on the work trajectory and causes the optical sensor to measure elapsed time and the displacement from when the robot receives the trigger signal, and
determines start time of the work by the tool based on data indicating the measured elapsed time and the measured displacement.

8. The robot system according to claim 7, wherein
the robot further includes a distance measuring device that measures a distance to the object, and
before measurement of the actual position,
the control device operates the robot arm so as to cause the robot arm to follow a plurality of teaching points constituting the work trajectory, obtains distance data measured by the distance measuring device at positions of the plurality of teaching points, and corrects the teaching points such that a distance from the tool to the object at each of the teaching points during the work by the robot approaches a reference set distance.

9. The robot system according to claim 8, wherein
the tool is a print head, and
the print head, the optical sensor, and the distance measuring device are arranged in a direction intersecting a moving direction of the print head.

10. The robot system according to claim 8, wherein
the tool is a print head,
the robot includes a movable stage disposed between the robot arm and the print head and configured to displace the print head, and
the print head, the optical sensor, and the distance measuring device are disposed on the movable stage and arranged in a moving direction of the print head.

11. The robot system according to claim 10, further comprising
a linear motion stage disposed between the robot arm and the print head, wherein
the linear motion stage is advanceable and retractable in the moving direction of the print head, and
the print head and the optical sensor move together with the advance and retraction of the linear motion stage.
